(19) United States
(12) Patent Application Publication
(10) Pub. No.: US 2002/0004099 A1
(43) Pub. Date: Jan. 10, 2002

(54) Process for producing chemical retarded lime

(75) Inventor: Mitsutoshi Ando, Tokyo (JP)

Correspondence Address: YOUNG & THOMPSON, 745 SOUTH 23RD STREET 2ND FLOOR, ARLINGTON, VA, 22202

(73) Assignee: YUKA SANGYO CO., LTD. and

(21) Appl. No.: 09/790,506

(22) Filed: Feb. 23, 2001

(30) Foreign Application Priority Data
Feb. 25, 2000 (JP) 50134/2000

(51) Int. Cl. B05D 7/00

(52) U.S. Cl. 427/212

(57) ABSTRACT

A process for producing chemical retarded lime comprises placing rough particles of lime into a chute, adding 0.01 to 5 parts by weight of a fatty acid per 100 parts by weight of the lime into the chute, dropping the lime from the chute, receiving the lime on a belt conveyor having a plurality of metal boards disposed alternately at right and left side portions and coating a surface of rough particles of the lime with the fatty acid while the lime is transferred by the belt conveyor.

Chemical retarded lime which is composed of rough particles coated with a fatty acid on the surface and exhibits suppressed reactivity when the lime is brought into contact with water can be produced by an economical apparatus.

### BACKGROUND OF THE INVENTION

1. Field of the Invention

The present invention relates to a process for producing chemical retarded lime. More particularly, the present invention relates to a process for producing chemical retarded lime, which is composed of rough particles coated with a fatty acid on the surface and exhibits suppressed reactivity when the lime is brought into contact with water, by an economical apparatus.

2. Description of Related Art

When lime is brought into contact with water, violent reaction takes place with vigorous generation of heat. However, fine particles and rough particles of lime coated with stearic acid or the like substance have a small reaction rate when the particles are brought into contact with water and are known as chemical retarded lime. In Japanese Patent Application Laid-Open No. Heisei 9(1997)-169551, the present inventor proposed a process for producing chemical retarded lime which exhibits uniformly suppressed reactivity. This process comprises adding stearic acid or the like to lime used as the raw material and pulverizing or grinding the resultant mixture. Moreover, it was found by the present inventor that chemical retarded lime obtained in accordance with this process exhibits an excellent effect on elimination of hazardous properties from hazardous substances contaminating the environment.

However, in the process proposed in Japanese Patent Application Laid-Open No. Heisei 9(1997)-169551, it is required that a fine pulverizer such as a vibrating mill or a rough grinder such as an impeller breaker be used and the cost of the apparatus increases. Therefore, a process for producing lime of suppressed reactivity to be more economical has been desired. During the studies to overcome the above problem, it was found that, as chemical retarded lime, lime in the form of rough particles does not easily generate dust and is more advantageous in handling than lime in the form of fine particles.

### SUMMARY OF THE INVENTION

The present invention has an object of providing a process for producing chemical retarded lime, which is composed of rough particles coated with a fatty acid on the surface and exhibits suppressed reactivity when the lime is brought into contact with water, by an economical apparatus.

As the result of intensive studies by the present inventor, it was found that the surface of rough particles of lime can be coated uniformly with a fatty acid and chemical retarded lime can be produced when rough particles of lime are placed into a chute, the fatty acid is added into the chute, the lime dropped from the chute is received on a belt conveyor having a plurality of metal boards disposed alternately at right and left side portions and the lime is transferred by the belt conveyor.

The present invention provides:

(1) A process for producing chemical retarded lime which comprises placing rough particles of lime into a chute, adding 0.01 to 5 parts by weight of a fatty acid per 100 parts by weight of the lime into the chute, dropping the lime from the chute, receiving the lime on a belt conveyor having a plurality of metal boards disposed alternately at right and left side portions and coating a surface of rough particles of the lime with the fatty acid while the lime is transferred by the belt conveyor and

(2) A process described in (1), wherein the fatty acid is stearic acid, oleic acid or soybean fatty acid.

The preferable aspects of the present invention further include:

(3) A process described in (1), wherein the rough particles of lime are placed into the chute using a belt conveyor.

(4) A process described in (1), wherein the fatty acid is added through spray nozzles.

(5) A process described in (1), wherein the amount of the fatty acid is 0.2 to 3 parts by weight per 100 parts by weight of the lime.

(6) A process described in (1), wherein the number of the metal board is from 2 to 12.

(7) A process described in (6), wherein the number of the metal board is from 3 to 9.

### BRIEF DESCRIPTION OF THE DRAWINGS

FIG. 1(a) shows a flow chart of the process of an embodiment of the present invention.

FIG. 1(b) shows a plan view of a second belt conveyor in an embodiment of the present invention.

FIG. 2 shows a diagram describing another embodiment of the present invention.

The numbers in the Figures have the following meanings:

1 Lime

2 A first belt conveyor

3 A chute

4 A spray nozzle

5 A second belt conveyor

6 A metal board

7 A tank of a fatty acid

9 A pipe

10 A facility for maintaining the temperature

### DESCRIPTION OF THE PREFERRED EMBODIMENTS

In the process for producing chemical retarded lime of the present invention, rough particles of lime are placed into a chute and 0.01 to 5 parts by weight of a fatty acid per 100 parts by weight of the lime is added to the lime in the chute. The lime is dropped from the chute and received on a belt conveyor having metal boards and the surface of the lime is coated with the fatty acid while the lime is transferred by the belt conveyor.

The size of the rough particles of lime used in the present invention which are obtained by roughly grinding lime is not particularly limited. It is preferable that the size is 10 mm or smaller and more preferably 6 mm or smaller. In the present invention, it is preferable that the rough particles of lime which are placed into the chute are heated at a temperature of 60° C. or higher and more preferably at a temperature of 60 to 90° C. When the temperature of lime is 60° C. or higher, the fatty acid melts and the surface of the rough particles of the lime can be coated uniformly even when the added fatty acid such as stearic acid is a solid substance at the natural temperature. In the present invention, lime which has been calcined, roughly ground and classified can be used immediately as prepared. Lime immediately after being calcined, roughly ground and classified is still kept at a high temperature and chemical retarded lime can be economically produced by utilizing the latent heat effectively.

In the process of the present invention, the method for placing the rough particles of lime into the chute is not particularly limited and, for example, a belt conveyor, a screw conveyor, a chain conveyor or a vibration conveyor can be applicable. Among these methods, a belt conveyor can be advantageously used since the belt conveyor has a simple structure, is excellent in the conveying ability, can be maintained by easy operations and can be used not only in the horizontal direction but also in directions inclined upward or downward. It is preferable that the carrying idler at the upper face of the belt conveyor has a sectional shape of a shallow gutter and the return idler at the lower face has a flat planar shape.

In the present process, the shape of the chute into which the rough particles of lime are placed is not particularly limited. For example, a chute which has an upper portion having a cylindrical shape and an outlet for lime mixed with the fatty acid at a lower portion can be used. Metal boards may be disposed in the chute, wherever necessary. In the present invention, a single chute may be used or, alternatively, two or more chutes may be used and the fatty acid may be added in separate two or more steps.

In the present process, the fatty acid added to lime in the chute is a fatty acid having 12 carbon atoms or more and is applicable even in a saturated or unsaturated fatty acid. Examples of the fatty acid include lauric acid, myristic acid, palmitic acid, stearic acid, arachidic acid, behenic acid, lauroleic acid, myristoleic acid, palmitoleic acid, oleic acid, gondoic acid, erucic acid, soybean fatty acid and coconut fatty oil. The fatty acid may be used singly or in combination of two or more. Among these fatty acids, stearic acid, oleic acid and soybean fatty acid are preferably used. It is not necessary that the fatty acid used in the process of the present invention has a high purity. For example, stearic acid having a titre of 52 to 56° C. can also be used.

In the present invention, the method of adding the fatty acid to lime in the chute is not particularly limited. For example, solid fatty acids can be added by a table feeder or a belt feeder and a liquid fatty acids can be added by a spray nozzle or a gear pump. Among these methods, the method using a spray nozzle is preferable since the fatty acid can be attached to the surface of the rough particles of lime almost uniformly. Even when the fatty acid is solid at the natural temperature, it is preferable that the fatty acid is heated at a temperature higher than the melting point and added using a spray nozzle.

In the present invention, it is preferable that the amount of the fatty acid added to lime in the chute is 0.01 to 5 parts by weight and more preferably 0.2 to 3 parts by weight per 100 parts by weight of lime. When the amount of the fatty acid is less than 0.01 part by weight per 100 parts by weight of lime, there is the possibility that the effect of suppressing the reactivity becomes insufficient. To suppress the reactivity of lime, it is sufficient that the fatty acid is used in an amount of 5 parts by weight or less per 100 parts by weight of lime. Addition of the fatty acid in an amount exceeding 5 parts by weight per 100 parts by weight of lime is disadvantageous not only with respect to the cost but also with respect to the possibility of secondary contamination of the environment in the use of chemical retarded lime.

In the present invention, the rough particles of lime dropped from the chute are received on a belt conveyor having a plurality of metal boards alternately disposed at right and left side portions. The number of the metal board is not particularly limited. It is preferable that the number of the metal board is 2 to 12 and more preferably 3 to 9. The number of the metal board can be suitably selected so that the surface of the rough particles of lime is uniformly coated with the fatty acid. The length of the belt conveyor can also be suitably selected in accordance with the number of the metal board. It is preferable that the metal board is disposed in a manner such that the top portion is inclined in the direction of transfer of the rough particles of lime and has a length such that the top portion is placed approximately at the middle of the width of the belt conveyor in the transverse direction. It is preferable that the carrying idler on the upper face of the belt conveyor has a sectional shape of a shallow gutter and the return idler at the lower face has a flat planar shape. When the rough particles of lime which are coated with the fatty acid on the surface are transferred by the belt conveyor having a plurality of the metal boards disposed alternately at right and left side portions, the rough particles of lime rub each other and are pushed alternately to the rightward and leftward directions on the belt conveyor due to the contact with the metal boards while the rough particles are transferred. Thus, the surface of the rough particles of lime is uniformly and completely coated with the fatty acid.

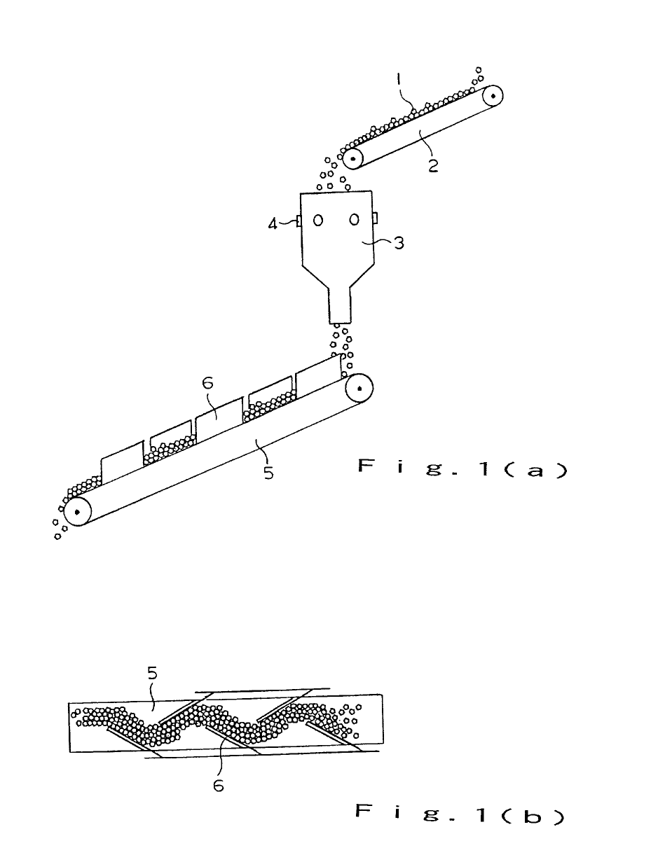

FIG. 1(a) shows a flow chart of the process of an embodiment of the present invention. FIG. 1(b) shows a plan view of a second belt conveyor in an embodiment of the present invention. Rough particles of lime 1 which are obtained by calcination, rough grinding and classification are placed into a chute 3 by a first belt conveyor 2. In the chute, spray nozzles 4 are disposed. A fatty acid is introduced in the form of fine liquid droplets and adhered to the surface of the rough particles of lime. The rough particles of lime adhered with the fatty acid are dropped from the chute on a second belt conveyor 5. In the present embodiment, five metal boards 6 are disposed on the second belt conveyor alternately at right and left side portions. The rough particles of lime attached with the fatty acid rub each other and are pushed alternately to the rightward and leftward directions on the belt conveyor due to the contact with the metal boards while the rough particles are transferred. Thus, the surface of the rough particles of lime is uniformly and completely coated with the fatty acid. It is preferable that the angles of the first belt conveyor and the second belt conveyor with respect to the horizontal direction can be changed each independently. It is preferable that the angles of the metal boards with respect to the direction of transfer by the belt conveyor can be changed each independently.

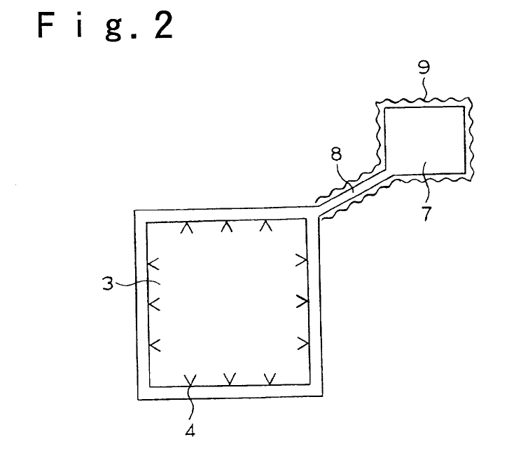

FIG. 2 shows a diagram describing another embodiment of the present invention. FIG. 2 shows a plan view of a tank of a fatty acid and a chute when looked at from an upper position. In the present embodiment, the chute 3 has a square sectional shape and twelve spray nozzles 4 are disposed in the chute. A fatty acid is kept in the tank of a fatty acid 7 and transferred to the spray nozzles disposed in the chute via a pipe 8. The tank of a fatty acid and the pipe are heated at a temperature of 60° C. or higher by a facility to maintain the temperature 9 and the fatty acid is kept in the liquid state.

In accordance with the process of the present invention, the surface of the rough gains of lime can be uniformly and completely coated with a fatty acid and chemical retarded lime can be easily produced.

To summarize the advantages of the present invention, in accordance with the present process, chemical retarded lime which is composed of rough particles coated with a fatty acid on the surface and exhibits suppressed reactivity when the lime is brought into contact with water can be produced by an economical apparatus.

### EXAMPLES

The present invention will be described more specifically with reference to examples in the following. However, the present invention is not limited to the examples.

### Example 1

Chemical retarded lime was produced in accordance with the process shown in FIG. 1. Rough particles of lime which were obtained by calcination, rough grinding and classification and having been in particle diameters of 5 mm or smaller were placed into a chute from a first belt conveyor in amount of 1 ton/hour. The temperature of the rough particles of lime was higher at inner portions than at the surface and was about 85° C. in average. The cylindrical portion of the chute had a diameter of 1 m and a height of 2 m and was made of stainless steel. At the inside of the cylindrical portion, 6 spray nozzles were disposed at positions separated by the same distance in the circumferential direction. Stearic acid having a titre of 55° C. which was melted by heating at 75° C. was introduced from the spray nozzles in the form of fine droplets in an amount of 10 kg/hour. The rough particles of lime dropped from the chute was received on a second belt conveyor. The second belt conveyor had a width of 50 cm and a length of 5 m and five metal boards having a length of 50 cm were disposed alternately at an angle of 30° with respect to the direction of transfer. The rough particles of lime attached with stearic acid rub each other and are pushed alternately to the rightward and leftward directions due to the contact with the five metal boards. The rough particles of lime which were dropped from the belt conveyor at the side of the head pulley were kept into a container as the product of chemical retarded lime.

The ability of the obtained lime to suppress the reactivity was evaluated by titration with hydrochloric acid. A stirrer rod having a diameter of 8 mm and a length of 35 mm was placed into a 1 liter beaker. Into the beaker, 500 ml of pure water was placed and phenolphthalein was added to water. The temperature of water was kept at 30° C. using a magnetic stirrer equipped with a heater (manufactured by SHIBATA KAGAKUKIKAI KOGYO Co., Ltd., THERMOMAGNESTIR MGH-311) and the stirrer rod was rotated at a speed of 200 rpm. Into the beaker, 10.0 g of the above chemical retarded lime was placed. A 4 mole/liter hydrochloric acid was added dropwise from a buret in an amount such that slight red color formed with phenolphthalein was kept remaining and the relation between the time passed after the chemical retarded lime was placed into the beaker and the amount of hydrochloric acid added to the mixture was obtained. The amount of hydrochloric acid was as follows: 3.8 ml after 1 minute, 15.6 ml after 2 minutes, 22.2 ml after 3 minutes, 27.6 ml after 4 minutes, 35.6 ml after 5 minutes, 41.9 ml after 6 minutes, 47.4 ml after 7 minutes, 53.8 ml after 8 minutes, 60.1 ml after 9 minutes, 62.8 ml after 10 minutes, 69.2 ml after 15 minutes, 73.2 ml after 20 minutes and 76.1 ml after 25 minutes.

### Comparative Example 1

The rough particles of lime used as the raw material for the chemical retarded lime in Examples 1 was used without any treatments and the titration with a 4 mole/liter hydrochloric acid was conducted in accordance with the same procedures as those conducted in Example 1.

The amount of hydrochloric acid was as follows: 42.7 ml after 1 minute, 55.0 ml after 2 minutes, 63.1 ml after 3 minutes, 68.0 ml after 4 minutes, 71.5 ml after 5 minutes, 74.1 ml after 6 minutes, 75.9 ml after 7 minutes, 77.4 ml after 8 minutes, 78.6 ml after 9 minutes and 79.4 ml after 10 minutes.

The results of titration obtained in Example 1 and Comparative Example 1 are shown in Table 1.

TABLE 1

Amount of added hydrochloric acid (ml)

| Time | Example 1 | Comparative Example 1 |
|---|---|---|
| 1 | 3.8 | 42.7 |
| 2 | 15.6 | 55.0 |
| 3 | 22.2 | 63.1 |
| 4 | 27.6 | 68.0 |
| 5 | 35.6 | 71.5 |
| 6 | 41.9 | 74.1 |
| 7 | 47.4 | 75.9 |
| 8 | 53.8 | 77.4 |
| 9 | 60.1 | 78.6 |
| 10 | 62.8 | 79.4 |
| 15 | 69.2 | — |
| 20 | 73.2 | — |
| 25 | 76.1 | — |

As shown in Table 1, the amounts of hydrochloric acid added in Example 1 were much less than those in Comparative Example 1. Thus, it is shown that the chemical retarded lime which is produced in accordance with the process of the present invention has an excellent chemical retardability to suppress the reactivity.

What is claimed is:

1. A process for producing chemical retarded lime which comprises placing rough particles of lime into a chute, adding 0.01 to 5 parts by weight of a fatty acid per 100 parts by weight of the lime into the chute, dropping the lime from the chute, receiving the lime on a belt conveyor having a plurality of metal boards disposed alternately at right and left side portions and coating a surface of rough particles of the lime with the fatty acid while the lime is transferred by the belt conveyor.

2. A process according to claim 1, wherein the fatty acid is stearic acid, oleic acid or soybean fatty acid.

3. A process according to claim 1, wherein the rough particles of lime are placed into the chute using a belt conveyor.

4. A process according to claim 1, wherein the fatty acid is added through spray nozzles.

5. A process according to claim 1, wherein the amount of the fatty acid is 0.2 to 3 parts by weight per 100 parts by weight of the lime.

6. A process according to claim 1, wherein the number of the metal board is from 2 to 12.

7. A process according to claim 6, wherein the number of the metal board is from 3 to 9.
